(19) United States
(12) Patent Application Publication
(10) Pub. No.: US 2003/0014878 A1
(43) Pub. Date: Jan. 23, 2003

(54) Tennis player's tape measure

(76) Inventor: Mickey Lee Smith, Winston-Salem, NC (US)

Correspondence Address: Mickey Lee Smith, 4721 Tolley Creek Drive, Winston-Salem, NC, 27106, US

(21) Appl. No.: 10/199,608

(22) Filed: Jul. 19, 2002

Related U.S. Application Data
(60) Provisional application No. 60/307,326, filed on Jul. 23, 2001.

(51) Int. Cl. G01B 3/10

(52) U.S. Cl. 33/759

(57) ABSTRACT

A specialized tape for a tape measure that is uniquely designed for determining whether the height of a tennis net complies with the net height regulations established in the rules of tennis. A user would simply extend the tape in a vertical fashion and compare the height of the center of the net (40) with the appropriate mark on the tape (15) that represents the regulation height of the net at its center point. Likewise, the user would compare the height of the net at one or both of the net posts (20 and 25) with the appropriate mark on the tape (12) that represents the regulation height of the net at the net posts.

### CROSS-REFERENCE TO RELATED APPLICATIONS

This application is entitled to the benefit of U.S. Provisional Patent Application No. 60/307,326 filed Jul. 23, 2001.

### FIELD OF THE INVENTION

The invention relates to a specialized tape for a tape measure that is uniquely designed for determining whether the height of a tennis net complies with the net height regulations established in the rules of tennis.

### BACKGROUND OF THE INVENTION

The rules of tennis, as defined by the International Tennis Federation, state the regulation height of a tennis net to be 36 inches (approximately 91.44 centimeters) at the net's center point, located halfway between the two net posts. The regulation height of the net at each of the two net posts which support the net is defined by the rules of tennis to be 42 inches (approximately 106.68 centimeters).

As will be obvious to most amateur tennis players, the tennis nets at many public courts are seldom maintained to the regulation height. Importantly, small changes in the height of the net can significantly change the degree of difficulty for putting or keeping a tennis ball in play during a tennis match. A net that is too high increases the difficulty of hitting the ball such that it is able to clear the net without sailing out of bounds. Conversely, a net that is too low unfairly allows shots to be hit with greater pace or at greater angles and still land within the bounds of the court.

In the tape measure art, it is known to make recoilable tapes which are marked off in specific lengths and units for taking measurements. It is also known to recoil these tapes onto a reel inside a housing.

It would be desirable to employ known conventional apparatus and methods for producing conventional tape measures in the mass production of a tennis player's tape measure. Moreover, it would be desirable to employ conventional apparatus and methods to produce packaging for a tennis player's tape measure.

### DESCRIPTION OF PRIOR ART

U.S. Pat. No. 5,071,126 describes a tennis bag with a built-in extension that allows the user to verify the net height using the length of the bag plus the extended piece. This approach is limited to checking the net height at the center net location and not at the net posts. It requires the user to utilize this specific tennis bag even if he/she would rather use another bag with other features for general tennis use. Additionally, a tennis bag would not be extremely accurate for determining the proper net height since it can bend and wrinkle.

U.S. Pat. No. 4,205,840 describes an article that when attached to a tennis racquet can be used to check the net height. This approach is limited to allowing the net height to be verified only at center court and not at the net posts. It also requires the user to attach something to his/her racquet to perform the net check and then remove it in order to play the match. Many tennis players would likely not find this convenient. Additionally, since this method requires that a tennis racquet hang from the net, the article's weight could pull down a loosely hung net and provide a false reading of the net height.

U.S. Pat. No. 320,569 describes an ornamental design for a telescoping rod that can be used to verify the proper net height. It has a hook to allow it to hang from the top of the net and its extended length corresponds with the regulation net height at center court. This invention is limited to checking the net height solely at the center net location and is not designed for verifying the net height at the net posts. Additionally, since this device hangs on the net, its weight could pull down a loosely hung net and provide a false reading of the net height.

U.S. Pat. No. 294,333 describes an ornamental design for a foldable device for verifying the proper net height. The device unfolds to a length equal to the regulation height of a tennis net. This invention is limited to verifying the net height solely at the center net location and is not designed for verifying the net height at the net posts. Additionally, this device would not easily be stored in a tennis bag since it would not be very compact in size.

U.S. Pat. No. D249,336 and D315,108 describe ornamental designs for devices which can be hung from the center of the net to verify the net's height. This approach is limited to allowing the net height to be verified only at the center net location and not at the net posts. Since this method requires that the device hang from the net, its weight could pull down a loosely hung net and provide a false reading of the net height. Additionally, each of these devices has a hook as part of its design which would likely get hung inside the user's tennis bag during storage.

A tennis player could use a standard tape measure or other conventional measuring tool to determine the height of the net. However, many tennis players are not familiar with the specific net height regulations and do not know how high the net should be set. Therefore, having a standard tape measure or other measuring tool would not be useful to these players.

### OBJECTS AND ADVANTAGES

Several objects and advantages of the invention are as follows: it facilitates the determination of whether the height of a tennis net complies with the net height regulations established in the rules of tennis without the user having to remember the regulation heights, it is very accurate, it stores compactly in a tennis bag, it is easy to use and understand, it doesn't require any other tennis equipment such as a tennis racquet or tennis bag to function properly, and it does not itself affect the height of the net while it is being used to verify the net height. It is also an object of the invention to have a design that can easily be manufactured on existing equipment to facilitate commercial viability and usefulness.

### SUMMARY

The invention relates to a specialized tape for a tape measure that is uniquely designed for determining whether the height of a tennis net complies with the net height regulations established in the rules of tennis. The tape contains two identified marks, each printed at a specific location on one surface of the tape. One mark is located on the tape at that distance from the leading end of the tape that corresponds to the regulation height of a tennis net at its center point. Currently, this height is defined as 36 inches (approximately 91.44 centimeters) by the International Tennis Federation. A second mark is located on the tape at that distance from the leading end of the tape that corresponds to the regulation height of a tennis net at each of the two net posts. Currently, this height is defined as 42 inches (approximately 106.68 centimeters) by the International Tennis Federation. Appropriate text may be printed adjacent to each mark in order to identify the respective mark. However, no other intervals, units, or other indicia are required on the tape. Should the regulations regarding the height of a tennis net be modified in the future, the new heights would define the location of the marks printed on the tape. The invention clearly intends to cover any future changes to the tennis regulations that govern net height and is not limited to the current regulation heights of 36 inches (approximately 91.44 centimeters) and 42 inches (approximately 106.68 centimeters) for the net height at center court and the net height at the net posts, respectively. It will be apparent to those skilled in the art that each mark can be one or more lines, one or more dots, a colored bar, or any other visible means for identifying a location on the tape.

In one preferred embodiment of the invention, the tape is approximately four feet long and one-fourth inch wide, made of metal or other conventional material and preferably is wound on a reel in a conventional type of retractable housing. The leading end of the tape contains a conventional hook that prevents the tape from being wound too far into the retractable housing. The tape has two marks printed on it at specific distances from the leading end of the tape. One mark is a line printed across the full width of the tape and is located 36 inches (approximately 91.44 centimeters) from the leading end of the tape. Adjacent to this mark is text describing the mark as the “Center Net Height.” The second mark is a line printed across the full width of the tape and is located 42 inches (approximately 106.68 centimeters) from the leading end of the tape. Adjacent to this mark is text describing the mark as the “Net Height At Posts.”

In another embodiment of the invention, the tape has only one identified mark printed on it. This mark is a line printed across the full width of the tape and is located 36 inches (approximately 91.44 centimeters) from the leading end of the tape. Adjacent to this mark is text describing the mark as the “Center Net Height.”

### DRAWINGS

FIG. 1 is a view of the portion of the tape that has a mark printed on it to indicate the regulation height of the tennis net at center court and a second mark printed on it to indicate the regulation height of the tennis net at each of the net posts.

FIG. 2 is a view of a tennis net and the points on it where regulation heights are defined.

### REFERENCE NUMERALS IN DRAWINGS

10 The tape measure tape.

12 The mark on the tape whose distance from the leading end of the tape represents the regulation height of the tennis net at the net posts. This height is currently defined as 42 inches (approximately 106.68 centimeters).

15 The mark on the tape whose distance from the leading end of the tape represents the regulation height of the tennis net at the net's center point. This height is currently defined as 36 inches (approximately 91.44 centimeters).

18 The leading end of the tape. This end would be placed on the court when using the tape to check the net height.

19 A conventional tape-measure-type hook.

20 One net post.

25 A second net post.

30 One singles stick

35 A second singles stick

40 Center net.

### DETAILED DESCRIPTION OF THE INVENTION

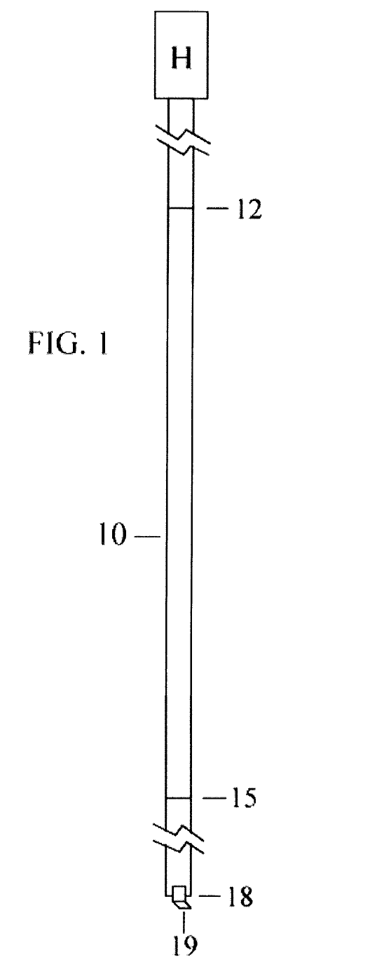

FIG. 1 is a view of the portion of the tape (10) that has two marks for determining if a tennis net is at regulation height. One mark (15) is located at that distance from the leading end of the tape (18) that corresponds to the regulation height of a tennis net at its center point (40). A second mark (12) is located at that distance from the leading end of the tape (18) that corresponds to the regulation height of a tennis net at each of the net posts (20 and 25). This mark (12) would also be used to verify the regulation net height at the point where singles sticks (30 and 35) would be used, if applicable. The tape would retract into a conventional retractable housing represented in FIG. 1 by an ‘H’ inside a rectangle. The tape would also have a conventional hook (19) on the leading end of the tape (18) that would prevent the tape from winding too far into the retractable housing.

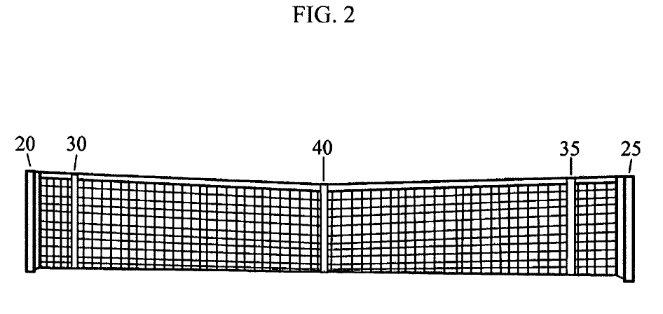

FIG. 2 is a view of a tennis net and the locations on it where the regulation heights are defined. The regulation height for each of these points on the net corresponds to one of the two marks printed on the tape measure's tape. The regulation height for the net posts (20 and 25) is currently defined as 42 inches (approximately 106.68 centimeters). If a singles match is played on a doubles court, singles sticks (30 and 35) are used to support the net to this same height of 42 inches (approximately 106.68 centimeters). A tie-down strap is used to pull the net at center court (40) to the current regulation height of 36 inches (approximately 91.44 centimeters).

While in the foregoing specification a detailed description of a specific embodiment of the invention was set forth for the purpose of illustration, it will be understood that many of the details herein given may be varied considerably by those skilled in the art without departing from the spirit and scope of the invention.

### OPERATION

The user would typically store the invention in his/her tennis bag until needed. Prior to playing a match, or anytime it is desired to verify that the net is at regulation height, the user would stand at the desired section of the net to be checked (center, net posts, or singles sticks) and simply place the leading end of the tape against the court and extend the tape from its retractable housing such that the tape is held adjacent to the net in a vertical fashion. The user would compare the height of the top of the net with the appropriate mark printed on the tape. For example, the height of the net at its center point would be compared to the lower mark on the tape that would be appropriately identified as the regulation height of the net at center court. The user could then raise or lower the net as would be appropriate for making the net conform to the regulation height as defined by the printed mark. Likewise, the height of the net at either net post would be compared to the upper mark on the tape that would be appropriately identified as the regulation height of the net at the net post. While the height of the net at the net posts is generally fixed and not easily changed, it is useful for a tennis player to know if the net at the net posts is significantly too high or too low. The player can then adjust his/her shots during the match to compensate for the net not being at the regulation height.

I claim:

1. A tape for a tape measure having one principal length-indicating mark which shall be approximately located on the tape at that distance from the leading end of the tape that corresponds to the regulation height of a tennis net at its center point, currently defined as thirty-six inches.

2. The tape of claim 1, further including a secondary length-indicating mark which shall be approximately located on the tape at that distance from the leading end of the tape that corresponds to the regulation height of a tennis net at the net posts, currently defined as forty-two inches.
